(19) United States
(12) Patent Application Publication
(10) Pub. No.: US 2009/0266749 A1
(43) Pub. Date: Oct. 29, 2009

(54) METHOD AND DEVICE FOR SORTING, SINGLING OUT AND/OR TRANSFERRING ITEMS OF LINEN

(76) Inventors: Engelbert Heinz, Vlotho (DE); Andreas Olivieri, Porta Westfalica (DE); Friedhelm Mehrhoff, Hille (DE); Alexander Farchmin, Kalletal (DE); Jan Hellmig, Dresden (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/429,002

(22) Filed: Apr. 23, 2009

(30) Foreign Application Priority Data
Apr. 29, 2008 (DE) 102008021502.3

(51) Int. Cl. B07C 5/342; B07B 7/00

(52) U.S. Cl. 209/580; 209/147

(57) ABSTRACT

The washing of items of linen is preceded by a plurality of treatments. The items of linen have to be singled out and sorted. In addition, processes for transferring the items of linen are required. In the past, items of linen have been singled out, sorted and transferred in an only partly automated manner. Manual activities are therefore still required. The invention provides for the items of linen to be singled out automatically, the singled-out items of linen to be transferred automatically from a conveyor to a transportation device, various sorting criteria to be determined automatically, in particular the color and the structure of the items of linen, and finally the items of linen to be sorted automatically in accordance with the detected sorting criteria in that they are blown downward at the intended point of a distributor conveyor. The measures according to the invention render manual activities superfluous.

### STATEMENT OF RELATED APPLICATIONS

This patent application is based on and claims the benefit of German Patent Application No. 10 2008 021 502.3 having a filing date of 29 Apr. 2008, which is incorporated herein in its entirety by this reference.

### BACKGROUND OF THE INVENTION

1. Technical Field

The invention relates to a method for sorting items of linen to be washed with at least one sorting criterion being determined on the items of linen hanging from at least one transportation device and/or with an individual item of linen being picked out from a pile of linen, transferred to a transportation device and sorted. The invention relates to a method for singling out items of linen with an individual item of linen being picked out from a pile of linen by a gripper which can move up and down. The invention relates to a method for transferring items of linen to a conveyor, in particular a transportation device, the item of linen being transferred by a transfer means from a preceding conveyor to the subsequent conveyor, in particular the transportation device. Furthermore, the invention relates to a device for singling out items of linen with a gripper which can move up and down for grasping an individual item of linen from a pile of linen. Furthermore, the invention relates to a device for transferring items of linen to a subsequent conveyor, with a gripper which can move up and down for grasping an individual item of linen from a pile of linen and a conveyor for transporting the item of linen onward to a subsequent conveyor. Furthermore, the invention relates to a device for sorting items of linen to be washed with a transportation device for the hanging onward transportation of the items of linen and with at least one device associated with the transportation device for determining at least one sorting criterion of the respective item of linen and/or with a transportation device for the hanging onward transportation of the items of linen and at least one device associated with the transportation device for determining at least one sorting criterion of the item of linen.

2. Related Art

The washing of items of linen is preceded by a plurality of treatments. Dirty linen, which is delivered to the laundry in for example linen bags, is found in a pile of usually different items of linen. This may be a mishmash of white linen and colored linen, in particular also a mixture of items of clothing and flat linen. Firstly, the items of linen have to be removed individually from the pile of linen before they can be sorted in accordance with various sorting criteria in order to be able to subsequently wash them in a manner meeting the requirements.

In the past, items of linen have been singled out and sorted partly in an automated manner, partly manually. Some of the manual activities take place also because the items of linen have repeatedly to be transferred to different devices for mechanizing the singling-out and the sorting.

### BRIEF SUMMARY OF THE INVENTION

Starting from the foregoing, the invention is based on the object of providing a method and a device with which items of linen to be washed (dirty linen) can automatically be prepared for washing.

A method for achieving this object is a method for sorting items of linen to be washed, at least one sorting criterion being determined on the items of linen hanging from at least one transportation device, wherein the color and/or structure, which is a sorting criterion, of the respective item of linen is determined by an image recognition. According to this, provision is made, during the sorting of dirty linen, to determine the color or structure, which is a sorting criterion, optionally also the color and structure, of the respective item of linen by an image recognition. The image recognition scans contactlessly a part of the respective item of linen that is sufficient to comment on the color or the structure of the item of linen. The structure, in particular, of the surface of the item of linen allows conclusions to be drawn as to the type of fabric, so that the respective item of linen can be sorted in accordance with the treatment, in particular washing, required for the type of fabric. Likewise, based on the color, the linen can for example be sorted into colored linen and white linen, which also requires different washing treatments.

Furthermore, provision is made in terms of the method for the image recognition to be carried out in a darkened region. This prevents in the region of the image recognition influencing of scattered light, thus ensuring the reliability and quality of the determination of the respective structure and/or color of the item of linen which is subjected to the image recognition.

According to a particular configuration of the method, provision is made for the items of linen to be transferred, once their at least one sorting criterion has been determined, to a distributor conveyor, preferably via a transfer conveyor. Preferably, the items of linen are discharged from the conveying system onto the transfer conveyor which deposits them gradually, in each case individually, onto the distributor conveyor. Thus, each individual item of linen can be supplied in accordance with the ascertained sorting criterion from the distributor conveyor in a purposeful manner to the respective individual treatment or be transferred into a respectively appropriate store for items of linen with sorting criteria allowing uniform treatment. In particular, compressed air is used for this purpose. This allows the items of linen to be sorted simply and rapidly in that the distributor conveyor, as it were, blows off the item of linen in question at the appropriate point of the distributor conveyor.

A further method for achieving the object mentioned at the outset, which may also be a development of the method described hereinbefore, is a method for sorting items of linen to be washed, an individual item of linen being picked out from a pile of linen, transferred to a transportation device and sorted, wherein the individual item of linen is transferred by one corner to a transportation clamp, in the state hanging from the transportation clamp at least one sorting criterion of the respective item of linen is determined, the item of linen is deposited on a distributor conveyor and removed at a point of the distributor conveyor corresponding to the sorting criterion. According to this, each individual item of linen is transferred by one corner to a transportation clamp of the transportation device. Preferably, in the state of the item of linen hanging from the transportation clamp, at least one sorting criterion of the respective item of linen is determined. Subsequently, the respective individual item of linen is if appropriate deposited on a distributor conveyor and removed pneumatically at a point of the distributor conveyor corresponding to the ascertained sorting criterion. This method allows a chain of pretreatments of the items of linen, all of which take place automatically, i.e. without manual intermediate steps.

Provision is preferably made for the respective item of linen to be checked in accordance with a plurality of sorting criteria along the conveying section of the transportation device, in particular for the structure and/or color of the respective item of linen. The color is important for sorting into colored linen and white linen, whereas the structure allows conclusions to be drawn as to the type of fabric of the respective item of linen. Thus, the items of linen can be supplied in a purposefully sorted manner to the required subsequent treatment. In this case, a further distinction may also be drawn within one sorting criterion, in that for example colored linen is sorted also in accordance with specific types of fabric. The sorting then takes place in accordance with a purposeful combination of a plurality of sorting criteria.

A further method for achieving the object mentioned at the outset is a method for singling out items of linen, an individual item of linen being picked out from a pile of linen by a gripper which can move up and down, wherein the gripper is introduced, before the grasping of an individual item of linen from the pile of linen, into the pile of linen by a specific degree. This method can also be a development of the methods described hereinbefore. In this method, provision is made for the gripper for singling out the items of linen to be introduced, before the grasping of an individual item of linen from the pile of linen, into the pile of linen by a specific degree, in particular a specific depth of immersion. As a result of the purposeful introduction of the gripper into the pile of linen, only a part, and preferably any desired part, of an item of linen enters the region of the gripper, thus ensuring that said gripper generally also grasps only an individual item of linen and singles out said item of linen by withdrawing it from the pile of linen. Preferably, provision is made to detect the depth to which the gripper is immersed into the pile of linen by a proximity sensor during the introduction of the linen gripper into the pile of linen. If the proximity sensor ascertains that the gripper has been introduced into the pile of linen by a specific, predefined degree, i.e. is touching the top item of linen, it can reliably grasp and raise an individual item of linen in order to withdraw it from the pile of linen and as a result to single it out.

A further method for achieving the object mentioned at the outset is a method for transferring an individual item of linen to a conveyor, in particular a transportation device, the item of linen being transferred by a transfer means from a preceding conveyor to the subsequent conveyor, in particular the transportation device, wherein the preceding conveyor is embodied as a belt conveyor on which the respective item of linen at least partly rests. The method can be developed by a method described hereinbefore or else a plurality of prescribed methods. In the method, provision is made for the item of linen to be transferred from one conveyor to a subsequent conveyor, the conveyor before the subsequent conveyor being formed preferably by at least one belt conveyor on which an individual item of linen, which is preferably singled out in advance, at least partly rests. The item of linen can be drawn up onto a belt conveyor of this type in that it lies with an upper region on the upper strand of the conveying belt of the belt conveyor, from which the adjoining parts of the item of linen hang down laterally, preferably on both sides. Such orientation of the item of linen is particularly suitable for the reliable automatic transfer thereof to the subsequent conveyor, which can be any desired conveyor.

Preferably, the item of linen is superimposed via the belt conveyor by a pneumatic means, in particular at least one blowing nozzle. Said blowing nozzle blows the item of linen, as it were, onto the belt conveyor. In this case, it is immaterial how the item of linen is previously oriented. In the simplest case, it hangs at any desired point from a gripper of a singling-out device.

A further configuration of the method provides for the item of linen to be transported through between the belt conveyor and a pressure means associated therewith. The pressure means presses the item of linen against the conveying belt of the belt conveyor, so that the item of linen, which for the most part hangs down even before the belt conveyor, does not slip down from the belt conveyor as a result of its inherent weight, but rather is entrained with frictional engagement as the drive of the conveying belt of the belt conveyor revolves. In this case, the item of linen is inevitably drawn over the belt conveyor.

A further preferred configuration of the method provides for an end or an end region of the item of linen, preferably a rear corner and/or a rear corner region of the item of linen, to be determined by at least one detection means on the conveyor before the subsequent conveyor. As the item of linen is drawn over the belt conveyor, a defined rear region of the item of linen, in particular in all cases a rear corner region thereof, is necessarily formed. As a result, it is possible to transfer in a purposeful manner a specific point, above all a corner, of the item of linen to the subsequent conveyor.

Furthermore, in terms of the method, provision is made for the onward transportation of the item of linen in the direction of transportation of the conveyor to be stopped when the detection means has determined the end, in particular the corner of the item of linen on the conveyor, in particular the belt conveyor. In the simplest case, the drive of the conveyor is for this purpose shut down. However, provision is preferably made to fix the end of the item of linen on the conveyor by a fixing member, such as for example a clamping means. This ensures that the item of linen, which now rests on the conveyor only at one end, preferably a corner region or a corner, is not drawn down by the conveyor, in particular the upper strand of the belt conveyor, owing to the weight of the remaining part of the item of linen that hangs down after the conveyor. The item of linen is thus reliably fixed on the stopped conveyor.

According to a proposal of the invention, the transfer of the end region of a respective item of linen, in particular a rear corner thereof, into the subsequent conveyor is carried out by a sword-like transfer means. The transfer means is located, viewed in the direction of transfer, before the item of linen hanging down from the preceding conveyor, in particular the belt conveyor. As a result of the forward movement of the sword-like transfer means, a rear part of the item of linen is placed around the sword-like transfer means, allowing said transfer means to transfer the item of linen by the rear corner region to the subsequent conveyor. Preferably, provision is made for the subsequent conveyor to have successive transportation clamps. The sword-like transfer means can then purposefully slide the rear corner region, which is placed therearound, of the item of linen into a transportation clamp, ensuring simple and reliable transfer of the rear corner region of the respective item of linen to the subsequent conveyor, that is to say, a transportation clamp thereof.

A device for achieving the object mentioned at the outset is a device for singling out items of linen, with a gripper which can move up and down for grasping an individual item of linen from a pile of linen, wherein a sensor, which determines the depth to which the gripper is immersed into the pile of linen, is associated with the gripper. In this device, a sensor, which determines the depth to which the gripper is immersed into the pile of linen, is associated with a gripper for withdrawing an individual item of linen from a pile of linen. This allows the gripper to be immersed into the pile of linen by a specific degree: precisely sufficiently far to enable it to reliably grasp an individual item of linen and withdraw it from the pile of linen.

Preferably, the sensor is embodied as a proximity sensor which controls the lowering movement of the gripper in the pile of linen in such a way that on reaching a predefined depth to which the gripper is immersed into the pile of linen, the downward movement of the gripper is stopped and the gripper can grasp the item of linen which has entered into contact therewith. The gripper is in all cases pressed into the pile of linen only sufficiently deeply to allow the top item of linen, with which the gripper enters into contact, to move purposefully into the jaw of the gripper sufficiently far that only this item of linen can be raised by the gripper out of the pile of linen and is in this case singled out. Because as a result of the proximity means the gripper is moved in all cases into the pile of linen at the same depth of immersion, only the top item of linen is at all times moved to the same degree into the jaw of the gripper, so that under all circumstances only an individual item of linen is ever grasped.

A further device for achieving the object mentioned at the outset, which may also be a preferred development of the device described hereinbefore, is a device for transferring an item of linen to a subsequent conveyor, with a gripper which can move up and down for grasping an individual item of linen from a pile of linen and a conveyor for transporting the item of linen onward to a subsequent conveyor, wherein there is associated with a trailing end, in the direction of conveyance, of the conveyor a detection means for determining a trailing end region of the item of linen which is transported onward by the conveyor in the direction of conveyance. According to this, a detection means is associated with a belt conveyor for removing the singled-out item of linen at the trailing end in the direction of conveyance, i.e. the end toward which the item of linen is transported by the belt conveyor. This detection means serves to determine a trailing end region, in particular a rear corner, of the item of linen which is transported away in the direction of conveyance in each case via the belt conveyor. As, in the item of linen hanging above the belt conveyor, the trailing end region thereof is formed in all cases by a rear corner of the item of linen, a specific point of the item of linen can at all times be reliably detected by the detection means. This ensures that always this specific point of the item of linen, preferably the rear corner thereof, is detected. This allows the item of linen to be transferred to the subsequent conveyor always at this specific point, automatically.

According to a development of the device, a fixing member is associated with the trailing end of the belt conveyor. Said fixing member serves to secure the trailing end region, in particular the rear corner region, of the item of linen on the belt conveyor. The fixing member can be activated by the detection means in that it then fixes the trailing end region of the item of linen once said trailing end region has been detected by the detection member and the belt conveyor is stopped or has been stopped. In the simplest case, the fixing can be a stopper which is actuated by a pneumatic cylinder or the like, is moved toward the upper strand of the belt conveyor and in this case fixes the end, in particular the rear corner, of the item of linen on the upper strand of the belt conveyor.

Furthermore, provision is made to assign a sword-like or else tongue-like transfer means to the trailing end of the belt conveyor. Preferably, the transfer means is arranged below the trailing end region of the belt conveyor and, in the direction of conveyance of the belt conveyor, displaceable beyond the end region thereof. The item of linen arrives in the direction of transportation before the sword-like transfer means when it is transported onward by the belt conveyor in the direction toward the subsequent conveyor, in particular a transportation device. When a rear corner of the item of linen is fixed to the trailing end of the belt conveyor, the trailing end region of the item of linen is located before the sword or tongue-like transfer means. Forward movement of the transfer means toward the subsequent conveyor places the trailing end of the item of linen around a plate-like tongue of the sword-like transfer means, allowing the trailing end of the item of linen to be transferred purposefully and reliably to the subsequent conveyor. Preferably, for this purpose, the sword-like transfer means is associated with the trailing end of the belt conveyor in such a way that the sword-like transfer means can insert the trailing end region, in particular a rear corner region, of the item of linen into an open transportation clamp of the subsequent conveyor, in particular of the transportation device.

A further device for achieving the object mentioned at the outset, which can also be a preferred development of the devices described hereinbefore, is a device for sorting items of linen to be washed with a transportation device for the hanging onward transportation of the items of linen and with at least one device associated with the transportation device for determining at least one sorting criterion of the respective item of linen, wherein at least one image recognition device is associated with the transportation device for determining at least one sorting criterion. This device is embodied in such a way that a transportation device forming the subsequent conveyor has at least one image detection device with which at least one sorting criterion of the items of linen can be determined. However, the image detection device also allows complex sorting criteria to be reliably detected, for example the color of the items of linen and/or the structure thereof, allowing conclusions to be drawn as to the type of fabric.

A further device for achieving the object mentioned at the outset is a device for sorting items of linen to be washed with a transportation device for the hanging onward transportation of the items of linen and at least one device associated with the transportation device for determining at least one sorting criterion of the item of linen, wherein a distributor conveyor is associated with the transportation device, and successive delivery points for sorted items of linen are arranged next to the distributor conveyor, in the direction of conveyance thereof. This device may also be a development of the devices described hereinbefore. This device provides for the assignment of a distributor conveyor, which is embodied preferably as a belt conveyor, to the transportation device, successive discharge points or stores for the sorted items of linen being associated next to the distributor conveyor, in the direction of conveyance thereof. Once their sorting criteria have been determined, the items of linen can be deposited individually in succession on the distributor conveyor and moved past the successive discharge points or stores. In this case, each item of linen is sorted in accordance with at least one ascertained sorting criterion, in that it is purposefully transferred, at the point provided for the at least one sorting criterion, from the distributor conveyor to the discharge station provided or the corresponding store.

A preferred development of the device provides for the assignment of blowing nozzles to the distributor conveyor, preferably at the side thereof opposing the discharge points or the stores. The blowing nozzles serve to transfer the respective item of linen from the distributor conveyor to the respective discharge point or the store in question. For this purpose, at least one blowing nozzle is provided at each discharge point or in the region of each store. The blowing nozzles allow a simple and reliable transfer of the respective item of linen to the store provided or the discharge point. In particular, the blowing nozzles allow rapid transfer of the items of linen to the stores or discharge points.

According to a further configuration of the invention, provision is made for a transfer device to be arranged between the transportation device and the distributor conveyor, in particular in the region of its start. The transfer device is associated with a defined point of the transportation device, a point following the determination of the last sorting criterion along the conveying section of the transportation device. The transfer device transfers an individual item of linen, which has been released by a transportation clamp of the transportation device, to the distributor conveyor. As a consequence of the transfer device, the distributor conveyor can have any desired spatial association with the transportation device, in that the transfer device can bridge the gap and above all also differences in height between the transportation device and the distributor conveyor. The transfer device also ensures that the items of linen reach the distributor conveyor individually in succession without any overlap, so that they can be sorted reliably and unambiguously along the distributor conveyor.

### BRIEF DESCRIPTION OF THE DRAWINGS

A preferred exemplary embodiment of the invention will be described hereinafter in greater detail with reference to the drawings, in which:

FIG. 1 is a plan view onto the device according to the invention.

FIG. 2 is a side view of a part of the device according to the invention, that is to say, in the region of the singling-out of the items of linen and transfer of singled-out items of linen to a transportation device.

FIG. 3 shows an enlarged detail Ill from FIG. 2.

### DETAILED DESCRIPTION OF PREFERRED EMBODIMENTS

The device shown here serves to automatically single out and sort items of linen to be washed. The items of linen are not shown in the figures.

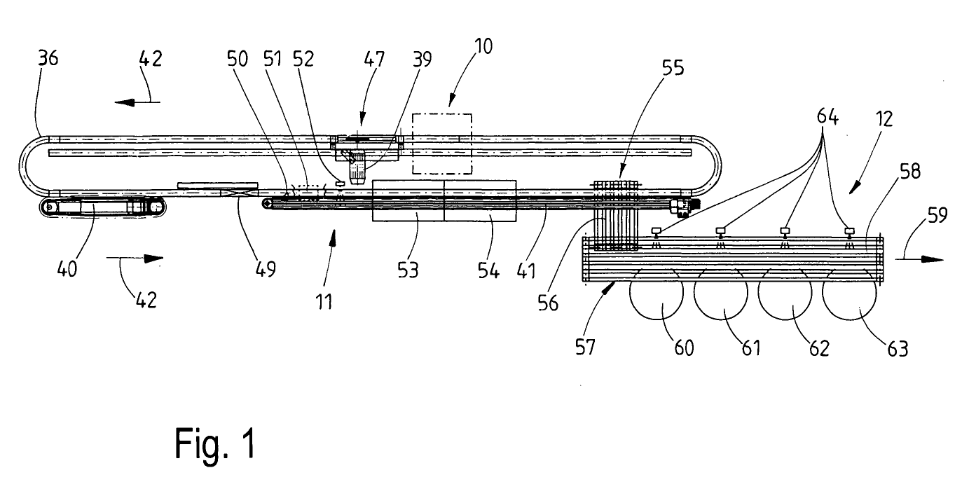

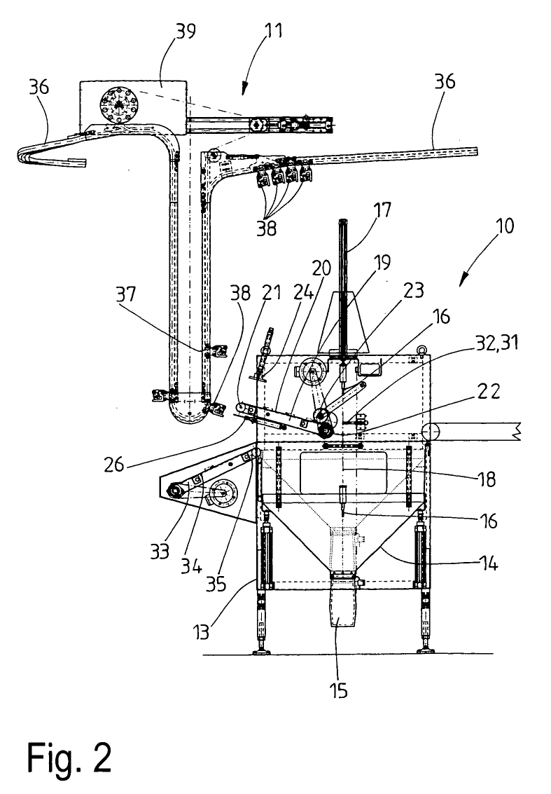

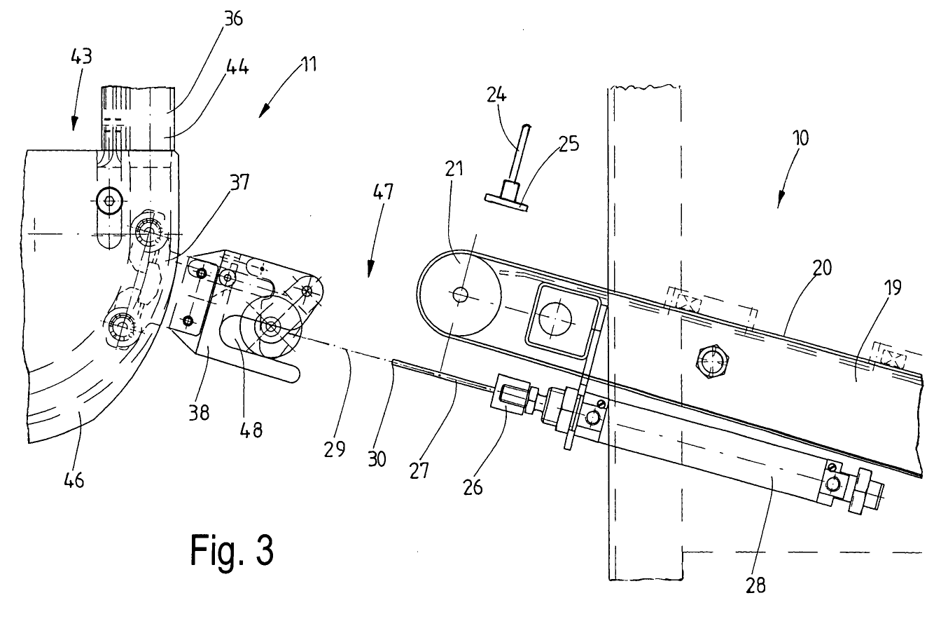

The device has a singling-out device 10, a subsequent transportation device 11 and also a sorting station 12 which is arranged downstream of the transportation device 11. FIG. 1 shows the singling-out device 10 only symbolically (by a dot-dash square). FIGS. 2 and 3 show the singling-out device 10 in detail. The singling-out device 10, the transportation device 11 and the sorting station 12 are embodied and linked to one another in such a way that a fully automatic preparation, in particular sorting, of the items of linen to be washed, that is to say, dirty linen, takes place for the subsequent washing process.

The singling-out device 10 has a mount 13 with a funnel 14 for receiving a pile of linen. The funnel 14, which has oblique side walls and is embodied in an in particular pyramid-shaped or spherical manner, can have at its tapering lower end a bag 15 (which is shown in FIG. 3) for collecting articles falling out of the items of linen, for example single-use syringes from doctor's white coats.

A gripper 16, which can move up and down along a perpendicular path of movement 18, is arranged above the funnel 14. The gripper 16 is located at the lower end of a lifting member which is mounted securely to the upper side of the mount 13 of the singling-out device 10 and may be for example a pneumatic cylinder 17. Other linear drives, such as for example spindle drives or rope drives, are also conceivable. A sensor, which may be for example a proximity sensor (not shown in the figures), is associated with the gripper 16. The pneumatic cylinder 17 moves the sensor, together with the gripper 16, up and down. The proximity sensor is used to determine the depth to which the opened gripper 16 is immersed into the pile of linen in the funnel 14. The sensor is linked to a controller which interrupts the downward movement of the gripper 16 into the pile of linen in the funnel 14 as soon as the proximity switch has detected a predefined depth to which the opened gripper 16 is immersed into the pile of linen. The controller also activates the closing of the gripper 16, which takes place at a specific depth of immersion, and the subsequent raising of the gripper 16 with an item of linen grasped thereby.

A belt conveyor 19 is arranged on a side next to the perpendicular path of movement 18 of the gripper 16. The belt conveyor 19 is located, based on the illustration in FIG. 2, at a small distance to the left, next to the path of movement 18, below the gripper 16 which is raised as far as possible. The belt conveyor 19 runs substantially horizontally. In the exemplary embodiment shown, an upper strand 20 of the belt conveyor 19 rises slightly in the direction of conveyance, that is to say, in the direction toward the transportation device 11. The belt conveyor 19 is of a length such that it ends next to the mount 13 of the sorting station 12. A trailing end 21 (viewed in the direction of conveyance) of the belt conveyor 19, which points toward the subsequent transportation device 11, is thus located outside the region of the sorting station 12.

In the exemplary embodiment shown, a pressure means 23 is associated with the leading end 22, pointing toward the path of movement 18, of the belt conveyor 19. This is, according to the illustration of FIG. 2, a non-driven, freely rotatable pressure roller which extends at least over a part of the width of the belt conveyor 19, and preferably has the same width. The pressure roller is arranged, viewed in the direction of conveyance, shortly after a driven deflection roller at the leading end 22 of the belt conveyor 19. The pressure roller of the pressure means 23 can be pressed against the upper strand 20 of the belt conveyor 19 with a predefined force, for example in a spring-loaded manner.

In the region of the trailing end 21, a detection means, which operates in a preferably contactless manner, is associated with the belt conveyor 19. The detection means (not shown in the figures) determines the trailing end, preferably a rear corner, of the item of linen traveling past the detection means in the region of the trailing end 21 of the belt conveyor 19.

A fixing member 24 is associated with the region of the trailing end 21 of the belt conveyor 19, at a distance above the upper strand 20 thereof. In the direction of conveyance of the belt conveyor 19, the fixing member 24 is located after the means for detecting the lagging end of the item of linen. In the exemplary embodiment shown, the fixing member 24 has a clamping plate 25 which can be moved by a linear drive which is securely mounted to the mount 13, for example a pneumatic cylinder, on a path of movement running perpendicularly to the upper strand 20 toward the upper strand 20 of the belt conveyor 19 for temporarily securing a trailing end, in particular a rear corner, of the item of linen on the belt conveyor 19.

Furthermore, a sword-like transfer means 26 is associated with the trailing end 21 of the belt conveyor 19. The transfer means 26 is fastened below the belt conveyor 19. The transfer means 26 is formed from a flat, plate-like tongue 27 which is fastened, by its side pointing toward the leading end 22 of the belt conveyor 19, to a linear drive, in particular a pneumatic cylinder 28. The pneumatic cylinder 28 can move the tongue 27 away, on a path of movement 29 running parallel below the upper strand 20 of the belt conveyor 19, toward the transportation device 11 and away therefrom again. When the tongue 27 has been fully moved back from the transportation device 11, a free end 30 thereof is located below the foremost point of the trailing end 21 of the belt conveyor 19.

Provided on the side opposing the belt conveyor 19, next to the perpendicular path of movement 18 of the gripper 16, is a supply means 31 which serves to transfer the singled-out item of linen hanging down from the gripper 16 to the belt conveyor 19. In the exemplary embodiment shown, the supply means 31 is formed by a blowing nozzle 32. However, a plurality of blowing nozzles 32, in particular a series of blowing nozzles 32 positioned next to one another, can also serve to form the pneumatic supply means 31. Alternatively, the supply means 31 can also be formed by mechanical slides or the like. The at least one blowing nozzle 32 is fixedly associated with the mount 13 with a direction of blowing onto the upper strand 20 at the leading end 22 of the belt conveyor 19. In the exemplary embodiment shown, in which the pressure means 23, which has a roller, is located above the leading end 22 of the belt conveyor 19, the blowing jet of the at least one blowing nozzle 32 is directed into a gap between the pressure roller of the pressure means 23 and the driven deflection drum at the leading end 22 of the belt conveyor 19.

A return conveyor 33 is securely arranged laterally next to the mount 13 below the trailing end 21, ending laterally next to the mount 13, of the belt conveyor 19 and the transfer means 26 below the belt conveyor 19. In the exemplary embodiment shown, the return conveyor 33 is embodied as a belt conveyor with an upper strand 34 rising slightly obliquely toward the mount 13. The revolving conveying belt of the return conveyor 33 is driven in such a way that the upper strand 34 collects an item of linen, which falls down during the transfer from the belt conveyor 19 to the subsequent transportation device 11, and returns it to the funnel 14 of the singling-out device 10. For this purpose, a trailing end 35, pointing toward the funnel 14, of the return conveyor ends in the region of an edge of the funnel 14 and protrudes preferably somewhat beyond the edge of the funnel 14, toward the center thereof.

The transportation device 11 has a revolving, endless path of conveyance which is formed from interconnected rail portions. The rail portions form a revolving conveying rail 36 in which a plurality of carriages 37 can move. Each carriage 37 carries a transportation clamp 38 into which an edge region of an item of linen, in particular a corner region of an item of linen, can be clamped. The transportation clamps 38 can be transported onward by the carriages 37 along the conveying rail 36, in some cases in a driven manner and in other cases in a non-driven manner. In descending sections of the transportation device 11, the carriages 37 can move without drive, with or without items of linen hanging therefrom. Along other portions of the conveying rail 36, in particular along horizontal or rising portions, the carriages 37, with the transportation clamps 38 arranged therebelow, are driven by for example a transportation chain which is driven so as to revolve. In the exemplary embodiment shown, revolving drives 39, 40, 41 are associated with only selected section portions of the conveying rail 36. Each drive 39, 40, 41 has a revolving conveying chain which is moved onward by for example an electric motor. The conveying chain has at uniform intervals entrainment means, such as for example transportation catches 50, which enter into contact with a respective carriage 37 or the transportation clamp 38 fastened thereto and in this case move the carriage 37, with the transportation clamp 38 arranged thereon, onward in the direction of transportation 42 along the conveying rail 36. The distance of the entrainment means of the conveying chain from the drives 39, 40 and 41 defines at the same time the distance at which the carriages 37 with the transportation clamps 38 are moved onward along the conveying rail 36.

The transportation device 11 has a loading station 43 shown in FIG. 2. In the region of this loading station 43, the conveying rail 36 has a U-shaped course with two parallel, perpendicular portions: a downward conveying portion 44 facing the singling-out device 10 and an upward conveying portion 45 positioned thereafter. At the lower end of the loading station 43, the downward conveying portion 44 and the upward conveying portion 45 are connected by a semicircular arc portion 46. The drive 39 transports the carriages 37, with a respective transportation clamp 38, set apart from one another through the loading station 43. A lower end region of the downward conveying portion 44 of the loading station 43 is located at a small distance before the trailing end 21 of the belt conveyor 19 of the singling-out device 10. This allows in each case an individual transportation clamp 38 to be positioned at a loading point 47 before the trailing end 21, pointing toward the loading station 43, of the belt conveyor 19. The transportation clamps 38 are arranged on the respective carriage 37 in such a way that at the loading point 47 the open side of a clamp jaw 48 of the respective transportation clamp 38 points toward the trailing end 21 of the belt conveyor 19, in such a way that the path of movement 29 of the tongue 27 of the transfer means 26 is directed into the clamp jaw 48 of the respective transportation clamp 38 which is held ready at the loading point 47.

The portion of the transportation device 11 that adjoins the loading station 43 can have any desired courses. Branches can also be provided to form a plurality of storage sections. The part of the transportation device 11 that adjoins the loading station 43 can run horizontally in a plane, but also in varying planes with rising sections and descending sections. FIG. 1 shows merely schematically a course of the conveying section of the transportation device 11, that is to say, an elongate oval. However, the inventions are not limited thereto. The oval of the conveying section has an elongate portion which is straight, viewed from above, and in which the loading station 43 is located. A straight portion parallel thereto is provided with the drives 40 and 41 which are separate from each other, the drive 41 extending over a large part of the length of the conveying rail 36 of the section portion pertaining thereto.

Various devices for determining the sorting criteria of the linen extend along the straight portion of the conveying rail 36 of the transportation device 11 with which the drives 40 and 41 are associated. In the exemplary embodiment shown, these are devices for determining the weight, the size, the color and the structure of the items of linen. An individual device is provided for each of the aforementioned sorting criteria, wherein these devices succeed one another directly and/or at a small distance in the direction of transportation 42 along the straight conveying section portion. Between the drives 40 and 41, there is associated with the conveying rail 36 a singling-out means 49 which singles out the carriages 37 with the transportation clamps 38 and the items of linen hanging down therefrom, that is to say, brings them to a defined distance relative to one another. This is followed by the drive 41 which has transportation catches 50 which are set apart from one another and transports the carriage 37 with the transportation clamps 38 and the items of linen hanging therefrom at a distance remaining uniform at all times through the region for determining the sorting criteria. Viewed in the direction of transportation 42, the singling-out means 49 is followed by a weighing device 51 which has a short portion of the conveying rail 36 that is separated from the preceding and subsequent part of the conveying rail 36. The short portion of the conveying rail 36 is suspended in the region of the weighing device 51 from a pair of scales with preferably at least one electronic weight transducer. This short portion of the conveying rail 36 in the region of the weighing device 51 is embodied in such a way that there is located therein at all times only one carriage 37 with a transportation clamp 38 and an item of linen hanging therefrom. Owing to the known weight of the short portion of the conveying rail 36, the carriage 37 and the transportation clamp 38, the weight of the item of linen hanging in each case from the transportation clamp 38 can be determined individually.

The weighing device 51 is followed in the direction of transportation 42 by a length measuring device 52. Said length measuring device has preferably an elongate, perpendicular sensor rod with which the lower end, in particular a lower corner, of the item of linen which hangs down freely from the transportation clamp 38 can be detected in a contactless manner. The length of the item of linen in the region of the length measuring device 42 can be calculated from the position of the sensor which detects the lower corner of the item of linen.

The length measuring device 52 is followed, viewed in the direction of transportation 42, by a color measuring device 53 and, immediately thereafter, a structure measuring device 54. The color measuring device 53 and the structure measuring device 54 have imaging detection means, in particular digital cameras. The images, which are detected by the digital cameras, from the color measuring device 53 and the structure measuring device 54 are evaluated preferably separately from one another. This evaluation takes place in such a way that the images obtained during the image detection allow conclusions to be drawn as to the color of the item of linen in the color measuring device 53 and the structure of the item of linen in the structure measuring device 54. As a result, it is possible to tell whether the respective item of linen is colored linen or white linen and what structure the respective item of linen has, from which conclusions may be drawn as to the material, in particular the fabric, of the respective item of linen. It is conceivable to provide only one common digital camera for the color measuring device 53 and the structure measuring device 54. Then, the color measuring device 53 and the structure measuring device 54 for all intents and purposes spatially collide. The jointly detected image is evaluated or processed further merely separately in accordance with the color and the structure of the respective item of linen.

Provided both in the region of the color measuring device 53 and in the region of the structure measuring device 54 is a housing-like cover or a tent-like curtain by which the respective item of linen is surrounded at least laterally and if appropriate from above. This produces a measuring space which is formed inside the housing or the tent-like curtain and partitions off the at least one camera of the color measuring device 53 and the structure measuring device 54 from ambient light or other external influences. It is thus possible to record, even without disruptive extraneous influences, in particular daylight, meaningful images of the respective item of linen.

Once, in the region of the transportation device 11, the sorting criteria of each individual item of linen hanging down from the transportation clamps 38 have been determined, at a discharge point 55 after the structure measuring device 54, each individual item of linen is gradually released from the transportation clamp 38 holding it and discharged onto an intermediate conveyor 56. Alternatively, at the discharge point 55, a chute can also be provided at the point of the intermediate conveyor 56. The intermediate conveyor 56 transports the discharged individual item of linen transversely to the direction of transportation 42 of the transportation device 11 onto a distributor conveyor 57 arranged next to the transportation device 11. In this case, the intermediate conveyor 57 bridges if appropriate a difference in height between the discharge point 55 and the distributor conveyor 57 which runs preferably horizontally. Preferably, the distributor conveyor 57 is located at a lower level compared to the discharge point 55, so that the item of linen, which at the discharge point 55 hangs down freely from the transportation clamp 38, can be discharged onto the intermediate conveyor 56 and placed thereby from above onto the distributor conveyor 57.

The distributor conveyor 57 is embodied preferably as a belt conveyor, on the upper strand 58 of which a plurality of items of linen, succeeding one another at a distance, can preferably be transported onward at the same time in the direction of sorting 59. The direction of sorting 59 can extend, as shown in FIG. 1, parallel to the direction of transportation 42 of the items of linen on the straight portion of the conveying rail 36, on which the sorting criteria are determined, but also antiparallel or transversely thereto. The distributor conveyor 57 is of sufficient length to be able to arrange at one side next to said distributor conveyor as many linen stores or other discharge points as are required for the sorting. In the exemplary embodiment shown, four, preferably identical, linen stores 60, 61, 62, 63 are arranged on one side next to the distributor conveyor 57. The linen stores 60 to 63 succeed one another at the same distance in the direction of sorting 59. The linen stores 60, 61, 62 and 63 may be linen carriages, linen bags or the like. It is however also conceivable to provide at the point of the linen stores 60 to 63, next to the distributor conveyor 57, a conveying system from which the sorted items of linen are supplied to the respective subsequent treatment device, for example different washing machine. The linen stores 60, 61, 62, 63 each receive items of linen for an identical subsequent treatment, in particular an identical wash. These are items of linen corresponding to the same sorting criteria. The invention is not limited to four linen stores 60, 61, 62 and 63 next to the distributor conveyor 57. It is also possible, if a plurality of sorting criteria are to be adhered to, for more than four linen stores 60, 61, 62, 63 to be arranged next to the distributor conveyor 57 which is then embodied so as to be correspondingly longer. Likewise, it is conceivable to arrange fewer than four linen stores 60, 61, 62 and 63 next to the distributor conveyor 57.

A series of blowing nozzles 64 are arranged on the longitudinal side of the distributor conveyor 57 that opposes the linen stores 60, 61, 62 and 63. In each case, at least one blowing nozzle 64 opposes a linen store 60, 61, 62 and 63, in that a jet of blowing air issuing from the respective blowing nozzle 64 is directed centrally onto the respective linen store 60, 61, 62 or 63. Vertically, the blowing nozzles 64 are arranged next to the distributor conveyor 57 in such a way that the jets of compressed air issuing from the blowing nozzles 64 flow past just above the upper strand 58 of the distributor conveyor 57 and in this case blow the respective item of linen transversely beyond the distributor conveyor 57 into the linen store 60, 61, 62 or 63 provided.

The methods according to the invention will be described hereinafter in greater detail with reference to the above-described device for automatically singling out, transferring and sorting items of linen.

The singling-out according to the invention with the singling-out device 10 begins with the withdrawing of a respective item of linen from the pile of linen. The pile of linen is located in the funnel 14 of the singling-out device 10. The items of linen are supplied to the funnel 14 continuously through a conveyor or discontinuously, that is to say, in lots. From the pile of linen which is formed in this case in the funnel 14, a respective individual item of linen is picked out in a singled-out manner by the gripper 16 which can move up and down. For this purpose, the gripper 16 is moved perpendicularly downward from an upper starting position by the pneumatic cylinder 17, until the proximity sensor or the like associated with the gripper 16 detects a specific depth to which the leading end or the tip of the gripper 16 is immersed into the pile of linen. The depth of immersion is determined in advance by tests, that is to say, defined in such a way that with maximum possible reliability at a specific depth of immersion the gripper grasps in all cases only one individual item of linen. If this specific depth of immersion is now ascertained by the proximity sensor, the downward movement of the gripper 16 is stopped and the gripper 16 closed. In this case, the gripper 16 grasps an individual item of linen at any desired point and subsequently the pneumatic cylinder 17 raises the gripper 16 with the individual item of linen hanging therefrom.

During the raising along the path of movement 18, the gripper 16 and the individual item of linen held thereby are moved through between the belt conveyor 19 and the pressure means 23 associated therewith, on one side, and the supply means 31, that is to say, the blowing nozzle 32, on the other side. When the item of linen is drawn right up, the center and the end of the first third thereof are located roughly between the belt conveyor 19 and the blowing nozzle 32. The blowing jet, which is directed into the gap between the leading end 22 of the belt conveyor 19 and the pressure means 23, of the blowing nozzle 32 now moves the item of linen between the leading end 22 of the belt conveyor 19 and the pressure means 23. The item of linen is then conveyed with frictional engagement into the gap between the belt conveyor 19 and the pressure means 23. This causes the item of linen to be drawn onto the belt conveyor 19 in that, that is to say, the item of linen hangs, with a leading end region in front, above the belt conveyor 19 in a roughly U-shaped manner, a central region of the item of linen being located on the upper strand 20 of the belt conveyor 19. As soon as the item of linen is drawn sufficiently far into the gap between the belt conveyor 19 and the contact means 23 that it can no longer fall down from the belt conveyor 19, the gripper 16 lets go of the grasped upper end which may be any desired point on any edge of the item of linen.

The belt conveyor 19 moves the item of linen onward to the trailing end 21 of the belt conveyor 19. In this case, a front part of the item of linen reaches beyond the trailing end 21, viewed in the direction of transportation, of the belt conveyor 19, so that it hangs freely downward before the trailing end 21 of the belt conveyor 19, that is to say, after the belt conveyor 19.

A detection means determines in a preferably contactless manner the trailing end of the item of linen on the upper strand 20 of the belt conveyor 19. This is in all cases a rear corner or a rear corner region of the item of linen. The rear corner is detected shortly before it has reached or passed the trailing end 21, pointing toward the transportation device 11, of the belt conveyor 19. The drive of the belt conveyor 19 is then stopped and the fixing member 24 fixes the trailing end or the rear corner region of the item of linen shortly before the trailing end of the belt conveyor 19. In this case, the rear corner region or the rear corner of the item of linen is secured between the upper strand 20 at the trailing end 21 of the belt conveyor 19 and the clamping plate 25, so that the item of linen, most of which now hangs down before the trailing end 21, does not slip down from the belt conveyor 19.

Provided below the trailing end 21 of the belt conveyor 19 is the return conveyor 33 which collects any item of linen which falls down and returns it to the funnel 14 of the singling-out device 10. The return conveyor 33 returns an item of linen of this type which has not been properly transferred to the subsequent transportation device 11. Even if the gripper 16 should exceptionally have grasped two items of linen at the same time, the return conveyor 33 returns the second item of linen to the funnel 14. If appropriate, the return conveyor 33 can also serve to support a lower region of the item of linen which hangs down before the trailing end 21 of the belt conveyor 19 and the rear corner of which has been fixed on the upper strand 20 of the belt conveyor 19 shortly before the trailing end 21.

Furthermore, the method according to the invention provides for the item of linen, the rear corner of which is held ready in the region of the trailing end 21 of the belt conveyor 19, to be transferred automatically to the transportation device 11, in each case into a transportation clamp 38. For this purpose, use is made of a transfer means 26 which introduces the trailing end region, in particular the rear corner region of the item of linen that is secured to the trailing end 21 of the belt conveyor 19, of the belt conveyor 19 into the transportation clamp 38.

The plate-like tongue 27 of the transfer means 26 can move back and forth on a rectilinear path of movement 29 which, in the exemplary embodiment shown, rises slightly toward the transportation clamp 28. The path of movement 29 opens out in the open clamp jaw 48 of the transportation clamp 38 which is held ready, momentarily stationary, before the transfer means 26 for the purposes of transfer. As the tongue 27 moves forward in the direction toward the transportation clamp 38, the rear corner region of the item of linen hanging down before the trailing end 21 is placed, with the back pointing away from the transportation clamp 38, around the free end 30 of the tongue 27. During the further forward movement, the tongue 27 enters the open clamp jaw 48, the rear corner region, part of which is placed around the tongue 37, of the item of linen entering into contact with the clamping surfaces of the clamp jaw 48 of the transportation clamp 38 and being secured in the automatically closing clamp jaw 48 of the transportation clamp 38 when the front part, which has been moved into the clamp jaw 48, of the tongue 27 is moved back into the region below the trailing end 21 of the belt conveyor 19. The free end 30 of the tongue 27 is formed by a preferably straight edge of the tongue 27 which runs perpendicularly to the path of movement 29 and is at least as wide as the transportation clamp 38.

With the movement of the tongue 27 of the transfer means 26 back into the starting position below the trailing end 21 of the belt conveyor 19, the transfer of the rear corner region or of the rear corner of the item of linen to a transportation clamp 38 of the transportation device 11 is concluded.

A large number of identical transportation clamps 38, into which the transfer means 26 transfers a respective item of linen from the singling-out device 10, are arranged along the transportation device 11. The items of linen which hang down and are held by the transportation clamp 38 on a rear corner are gradually moved continuously onward along a conveying rail 36 which is conventionally formed from a plurality of portions. The conveying rail 36 defines the course, which may be any desired one, of the conveying section of the transportation device 11. As a result of the plurality of transportation clamps 38, the transportation device 11 serves also as an intermediate store for a plurality of singled-out items of linen. The drives 39 to 41 are associated with certain portions of the conveying rail 36. The drive 39 in the region of the loading station 43 of the transportation device 11 serves to transport the empty transportation clamps 38 at a purposeful distance from one another on the downward conveying portion 44 to the loading point 47 and to stop them there briefly for the purposes of transfer of an item of linen from the singling-out device 10. At the same time, the drive 39 halts in all cases briefly an empty transportation clamp 38 at the loading point 47. The drive 39 is the only one which drives the transportation clamps 38 with brief interruptions, i.e. discontinuously. That is to say, for the remainder, the transportation clamps 38 are driven continuously. A rear corner of an item of linen is inserted from the tongue 27, which is moved on the path of movement 29 into the open clamp jaw 48, of the transfer means 26 into the open clamp jaw 48 of the transportation clamp 38 which is momentarily stationary at the loading point 47. After the hanging of an item of linen into the respective transportation clamp 38 at the loading station 43, the drive 39 moves the upward conveying portion 45 of the respective loaded transportation clamp 38 upward and brings it to a level such that the loaded transport clamps 38 subsequently move onward automatically, i.e. without a drive, over a large part of the conveying rail 36 of the transportation device 11.

Before a singling-out means 49 in the course of the conveying rail 36, the drive 40 supplies the loaded transportation clamps 38 to the singling-out means 49. In this case, the loaded transportation clamps 38 follow on in quick succession, if appropriate at any desired distance.

In the region of the singling-out means 49, the transportation clamps 38, with items of linen hanging therefrom, are gradually fed into the subsequent region of the conveying rail 36 and transported onward by the transportation catches 50 of the drive 41 at a predetermined defined distance from one another. During this onward transportation, a transportation clamp 38, with an item of linen hanging down freely therefrom, enters the region of the weighing device 51 which determines the weight of the item of linen hanging in each case from the transportation clamp 38. Following the determination of the weight, the transportation clamp 38 with the item of linen is transported past the length measuring device 52. Here, the length of the item of linen hanging down from the transportation clamp 38 is determined by a preferably perpendicular sensor strip. After the measurement of the length, the item of linen is transported by a color measuring device 54 and the subsequent structure measuring device 54. In both, the color and the structure of the respective item of linen hanging down from the transportation clamp 28 are determined in a contactless manner by at least one imaging method, preferably only qualitatively. It is thus sufficient, for measuring the color, that it is recognized whether the item of linen is a light (white) item of linen or a dark item of linen (colored linen). During the measuring of the structure of the item of linen, the differences in height between the highest and lowest regions of the fabric are determined, from which conclusions may be drawn as to whether the item of linen is a coarsely structured item of linen (for example terry cloth) or a finely structured item of linen (for example flat linen). The transportation clamps 38 are transported, with the items of linen hanging therefrom, at a uniform distance which is sufficient for the measurements without interruption of the movement, i.e. continuously, through the weighing device 51, the length measuring device 52, the color measuring device 53 and the structure measuring device 54.

The measured weight of each individual item of linen, the length, the color and the structure are sorting criteria for the subsequent sorting of the items of linen. The sorting can take place in accordance with individual sorting criteria, but also in accordance with a combination of a plurality of sorting criteria. For example, the sorting takes place into colored linen and white linen. In this case, a distinction may be drawn between large and heavy items of linen and small and light items of linen. For example, sorting is then carried out into small colored linen and large colored linen and small and large table linen. Particular sorting can take place in accordance with specific fabrics, for example coarsely structured fabrics such as terry cloth. Items of linen made of terry cloth can also be sorted into white and colored items of linen and/or large and small items of linen.

According to a particular method according to the invention, the items of linen are sorted in the sorting station 12. This takes place on determination of the last sorting criteria, i.e. in the exemplary embodiment shown on the structure measuring device 54.

During the continuous onward movement along the conveying rail 36, each individual item of linen is released, once the sorting criteria have been determined, from the transportation clamp 38 and discharged at the discharge point 55 onto an intermediate conveyor 56. Successive items of linen are discharged from the transportation clamps 38 at an interval such that the items of linen individually bit by bit reach the intermediate conveyor 56.

In the exemplary embodiment shown, the intermediate conveyor 56 transports the respectively discharged item of linen onward from the discharge point 55 onto the distributor conveyor 57 transversely to the course of the conveying rail 36. The intermediate conveyor 56 can transport the respective item of linen onward, as required, horizontally or else so as to rise or fall, depending on the level at which the distributor conveyor 57 is located.

The distributor conveyor 57 transports the respective item of linen in the direction of sorting 59 which, in the exemplary embodiment shown, runs parallel to the portion of the conveying rail 36 in the region of the discharge point 55, past the individual sorting points. In the exemplary embodiment shown, the upper strand 58 of the distributor conveyor 57 lies in a horizontal plane and runs rectilinearly in the direction of sorting 59. A plurality of successive sorting points, which in the exemplary embodiment shown are embodied as linen stores 60, 61, 62 and 63, are arranged on one side next to the distributor conveyor 57. However, the invention is not limited to four linen stores 60 to 63. Depending on the number of criteria in accordance with which the items of linen are to be sorted, a corresponding number of linen stores 60 to 63 or other sorting points are arranged on one side next to the distributor conveyor 57. Blowing nozzles 64, which succeed one another at a distance, are located on the longitudinal side of the distributor conveyor 57 that opposes the linen stores 60 to 63. During the continuous onward transportation of the distributor conveyor 57 perpendicularly to the direction of sorting 59, the blowing nozzles 64 blow the respective item of linen from the distributor conveyor 57 down into the linen store 60, 61, 62 or 63 provided. If, for example, the respective item of linen fulfils the sorting criteria for items of linen in the linen store 63, it is transported by the distributor conveyor 57 in the direction of sorting 59 past the linen stores 60, 61, 62 up to the linen store 63. When the item of linen in question is located before or next to the linen store 63, the blowing nozzle 64 is activated, which moves the item of linen down from the upper strand 58 of the distributor conveyor 57 transversely to the direction of sorting 59, that is to say, it is blown down, into the linen store 63. At the same point in time, a plurality of items of linen may be located on the distributor conveyor 57. However, these items of linen are at a distance which is sufficient in order to purposefully transfer only one individual item of linen into the linen store 60, 61, 62 or 63 provided.

The invention is distinguished by a plurality of methods and devices which are patentable individually and have been described together hereinbefore. Protection is claimed for an overall system, both of a method and of a device, but also for the individual methods and devices for singling out the items of linen, for transferring the singled-out items of linen to the transportation device 11, for determining criteria for sorting the items of linen, and for sorting the items of linen.

### LIST OF REFERENCE NUMERALS

10 Singling-out device
11 Transportation device
12 Sorting station
13 Mount
14 Funnel
15 Collecting bag
16 Gripper
17 Pneumatic cylinder
18 Path of movement
19 Belt conveyor
20 Upper strand
21 Trailing end
22 Leading end
23 Pressure means
24 Fixing member
25 Clamping plate
26 Transfer means
27 Tongue
28 Pneumatic cylinder
29 Path of movement
30 Free end
31 Supply means
32 Blowing nozzle
33 Return conveyor
34 Upper strand
35 Trailing end
36 Conveying rail
37 Carriage
38 Transportation clamp
39 Drive
40 Drive
41 Drive
42 Direction of transportation
43 Loading station
44 Downward conveying portion
45 Upward conveying portion
46 Arc portion
47 Loading point
48 Clamp jaw
49 Singling-out means
50 Transportation catch
51 Weighing device
52 Length measuring device
53 Color measuring device
54 Structure measuring device
55 Discharge point
56 Intermediate conveyor
57 Distributor conveyor
58 Upper strand
59 Direction of sorting
60 Linen store
61 Linen store
62 Linen store
63 Linen store
64 Blowing nozzle

What is claimed is:

1. A method for sorting items of linen to be washed, at least one sorting criterion being determined on the items of linen hanging from at least one transportation device (11), wherein the color and/or structure, which is one of the at least one sorting criterion, of the respective item of linen is determined by an image recognition.

2. The method as claimed in claim 1, wherein the image recognition is carried out in a darkened region along the transportation device (11) during the continuous onward transportation of the respective item of linen through the region of the image recognition.

3. The method as claimed in claim 1, wherein the items of linen are individually transferred, once the at least one sorting criterion has been determined, to a distributor conveyor (57), via an intermediate conveyor (56).

4. The method as claimed in claim 2, wherein the items of linen are individually transferred, once the at least one sorting criterion has been determined, to a distributor conveyor (57), via an intermediate conveyor (56).

5. The method as claimed in claim 1, wherein compressed air moves the items of linen, sorted in accordance with the at least one sorting criterion, away from the distributor conveyor (57).

6. A method for sorting items of linen to be washed, an individual item of linen being picked out from a pile of linen, transferred to a transportation device and sorted, wherein the individual item of linen is transferred by one corner to a transportation clamp (38), in the state hanging from the transportation clamp (38) the at least one sorting criterion of the respective item of linen is determined, the item of linen is deposited on a distributor conveyor (57) and removed at a point of the distributor conveyor (57) corresponding to the at least one sorting criterion.

7. The method as claimed in claim 6, wherein along a conveying section of the transportation device (11), each item of linen is checked for a plurality of the at least one sorting criterion and the sorting takes place as a function of the at least one of the sorting criterion.

8. A method for singling out items of linen, an individual item of linen being picked out from a pile of linen by a gripper (16) which can move up and down, wherein the gripper (16) is introduced, before the grasping of an individual item of linen from the pile of linen, into the pile of linen by a specific depth.

9. The method as claimed in claim 8, wherein the depth to which the gripper (16) is immersed into the pile of linen is determined by a distance sensor.

10. A method for transferring an individual item of linen to a conveyor, the conveyor being a transportation device (11), comprising transferring the item of linen by a transfer means (26) from a preceding conveyor to the transportation device (11), wherein the preceding conveyor is a belt conveyor (19) on which the respective item of linen at least partly rests.

11. The method as claimed in claim 10, wherein the respective item of linen is pneumatically superimposed via the belt conveyor (19).

12. The method as claimed in claim 10, wherein the respective item of linen is transported through between the belt conveyor (19) and a pressure means (23) associated with the belt conveyor (19) in the direction toward the transportation device (11).

13. The method as claimed in claim 10, wherein on the preceding conveyor a rear corner of the item of linen is determined by at least one detection means.

14. The method as claimed in claim 10, wherein when the at least one detection means determines the end of the item of linen on the preceding conveyor, the onward transportation of the item of linen in the direction of transportation of the preceding conveyor is stopped and a fixing member (24) fixes the rear corner of the respective item of linen on the preceding conveyor.

15. The method as claimed in claim 10, wherein in the region of a trailing end (21), viewed in the direction of conveyance, of the preceding conveyor, a sword-like transfer means (26) transfers the item of linen in the region of the rear corner from the preceding conveyor to the transportation device (11).

16. The method as claimed in claim 10, wherein the transfer means (26) transfers a region of the rear corner of the respective item of linen from the preceding conveyor into a transportation clamp (38) of the transportation device (11).

17. The method as claimed in claim 10, wherein the sword-like transfer means (26) slides the respective item of linen of the rear corner into a clamp jaw (48) of a transportation clamp (38) which is held ready for the purposes of transfer momentarily before the transfer means (26).

18. A device for singling out items of linen, with a gripper (16) which can move up and down for grasping an individual item of linen from a pile of linen, comprising a sensor, which determines the depth to which the gripper (16) is immersed into the pile of linen, associated with the gripper (16).

19. The device as claimed in claim 18, wherein the sensor is embodied as a distance sensor which controls the lowering movement of the gripper (16) into the pile of linen in such a way that on reaching a predetermined depth to which the gripper (16) is immersed into the pile of linen, the downward movement of the gripper (16) is stopped and the gripper (16) grasps an item of linen which is brought into contact therewith.

20. A device for transferring an item of linen to a subsequent conveyor, comprising a gripper (16) which can move up and down for grasping an individual item of linen from a pile of linen and a conveyor for transporting the item of linen onward to a subsequent conveyor, wherein there is associated with a trailing end (21), in the direction of conveyance, of the conveyor a detection means for determining a trailing end region of the item of linen which is transported onward by the conveyor in the direction of conveyance.

21. The device as claimed in claim 20, further comprising a fixing member (24) for securing the end region of the item of linen on the conveyor, the fixing member (24) being associated with the trailing end (21) of the conveyor, wherein the fixing member (24) is activated by the detection means once the detection means has determined the rear corner of the item of linen on the trailing end (21) of the conveyor.

22. The device as claimed in claim 20, wherein a sword-like transfer means (26) is associated with the trailing end (21) of the conveyor.

23. The device as claimed in claim 20, wherein a sword-like transfer means (26) is associated with the trailing end (21) of the conveyor in such a way that the sword-like transfer means (26) can insert the respective item of linen with the region of the rear corner into a transportation clamp (38) of the subsequent conveyor.

24. A device for sorting items of linen to be washed comprising a transportation device (11) for the hanging onward transportation of the items of linen and at least one device associated with the transportation device (11) for determining at least one sorting criterion of the respective item of linen, wherein at least one image recognition device is associated with the transportation device (11) for determining the at least one sorting criterion.

25. A device for sorting items of linen to be washed comprising a transportation device (11) for the hanging onward transportation of the items of linen and at least one device associated with the transportation device (11) for determining at least one sorting criterion of the item of linen, wherein a distributor conveyor (57) is associated with the transportation device (11), and successive delivery points for sorted items of linen are arranged next to the distributor conveyor (57), in the direction of conveyance thereof.

26. The device as claimed in claim 25, further comprising blowing nozzles (64) associated with the distributor conveyor (57) on the side opposing the delivery points for transferring in each case an individual item of linen from the distributor conveyor (57) to the respective delivery point.

27. The device as claimed in claim 25, further comprising a point (55) for discharging items of linen to be sorted onto the distributor conveyor (57) arranged between the transportation device (11) and the distributor conveyor (54) in the region of the start of the distributor conveyor (57).

28. The device as claimed in claim 27, further comprising an intermediate conveyor (56) arranged at the discharge point (55) between the transportation device (11) and the distributor conveyor (57).
